(19) United States
(12) Patent Application Publication
(10) Pub. No.: US 2005/0185711 A1
(43) Pub. Date: Aug. 25, 2005

(54) 3D television system and method

(76) Inventors: Hanspeter Pfister, Arlington, MA (US); Wojciech Matusik, Arlington, MA (US)

Correspondence Address: Patent Department;Mitsubishi Electric Research Laboratories, Inc., 201 Broadway, Cambridge, MA, 02139, US

(21) Appl. No.: 10/783,542

(22) Filed: Feb. 20, 2004

(51) Int. Cl. H04N 7/12; H04N 13/04

(52) U.S. Cl. 375/240.01; 348/51

(57) ABSTRACT

A three-dimensional television system includes an acquisition stage, a display stage and a transmission network. The acquisition stage includes multiple video cameras configured to acquire input videos of a dynamically changing scene in real-time. The display stage includes a three-dimensional display unit configured to concurrently display output videos generated from the input videos. The transmission network connects the acquisition stage to the display stage.

### FIELD OF THE INVENTION

This invention relates generally to image processing, and more particularly to acquiring, transmitting, and rendering auto-stereoscopic images.

### BACKGROUND OF THE INVENTION

The human visual system gains three-dimensional information in a scene from a variety of cues. Two of the most important cues are binocular parallax and motion parallax. Binocular parallax refers to seeing a different image of the scene with each eye, whereas motion parallax refers to seeing different images of the scene when the head is moving. The link between parallax and depth perception was shown with the world's first three-dimensional display device in 1838.

Since then, a number of stereoscopic image displays have been developed. Three-dimensional displays hold a tremendous potential for many applications in entertainment, advertising, information presentation, tele-presence, scientific visualization, remote manipulation, and art.

In 1908, Gabriel Lippmann, who made major contributions to color photography and three-dimensional displays, contemplated producing a display that provides a “window view upon reality.”

Stephen Benton, one of the pioneers of holographic imaging, refined Lippmann's vision in the 1970s. He set out to design a scalable spatial display system with television-like characteristics, capable of delivering full color, 3D images with proper occlusion relationships. That display provided images with binocular parallax, i.e., stereoscopic images, which can be viewed from any viewpoint without special lenses. Such displays are called multi-view auto-stereoscopic because they naturally provide binocular and motion parallax for multiple viewers.

A variety of commercial auto-stereoscopic displays are known. Most prior systems display binocular or stereo images, although some recently introduced systems show up to twenty-four views. However, the simultaneous display of multiple perspective views inherently requires a very high resolution of the imaging medium. For example, maximum HDTV output resolution with sixteen distinct horizontal views requires 1920×1080×16 or more than 33 million pixels per output image, which is well beyond most current display technologies.

It has only recently become feasible to deal with the processing and bandwidth requirements for real-time acquisition, transmission, and display of such high-resolution content.

Today, many digital television channels are being transmitted using the same bandwidth previously occupied by a single analog channel. This has renewed interest in the development of broadcast 3D TV. The Japanese 3D Consortium and the European ATTEST project have each set out to develop and promote I/O devices and distribution mechanisms for 3D TV. The goal of both groups is to develop a commercially feasible 3D TV standard that is compatible with broadcast HDTV, and that accommodates current and future 3D display technologies.

However, so far, no fully functional end-to-end 3D TV system has been implemented.

Three-dimensional TV is described in literally thousands of publications and patents. Because this work covers various scientific and engineering fields, an extensive background is provided.

Lightfield Acquisition

A lightfield represents radiance as a function of position and direction in regions of space that is free of occluders. The invention distinguishes between acquisition of lightfields without scene geometry and model-based 3D video.

One object of the invention is to acquire a time-varying lightfield passing through a 2D optical manifold and emitting the same directional lightfield through another 2D optical manifold with minimal delay.

Early work in image-based graphics and 3D displays has dealt with the acquisition of static lightfields. As early as 1929, a photographic multi-camera recording method for large objects, in conjunction with the first projection-based 3D display, was described. That system uses a one-to-one mapping between photographic cameras and slide projectors.

It is desired to remove that restriction by generating new virtual views in a display unit with the help of image-based rendering.

Acquisition of dynamic lightfields has only recently become feasible, Naemura et al. “Real-time video-based rendering for augmented spatial communication,” Visual Communication and Image Processing, SPIE, 620-631, 1999. They implemented a flexible 4×4 lightfield camera, and a more recent version includes a commercial real-time depth estimation system, Naemura et al., “Real-time video-based modeling and rendering of 3d scenes,” IEEE Computer Graphics and Applications, pp. 66-73, March 2002.

Another system uses an array of lenses in front of a special-purpose 128×128 pixel random-access CMOS sensor, Ooi et al., “Pixel independent random access image sensor for real time image-based rendering system,” IEEE International Conference on Image Processing, vol. II, pp. 193-196, 2001. The Stanford multi-camera array includes 128 cameras in a configurable arrangement, Wilburn et al., “The light field video camera,” Media Processors 2002, vol. 4674 of SPIE, 2002. There, special-purpose hardware synchronizes the cameras and stores the video streams to disk.

The MIT lightfield camera uses an 8×8 array of inexpensive imagers connected to a cluster of commodity PCs, Yang et al, “A real-time distributed light field camera,” Proceedings of the 13^{th} Eurographics Workshop on Rendering, Eurographics Association, pp. 77-86, 2002.

All those systems provide some form of image-based rendering for navigation and manipulation of the dynamic lightfield.

Model-Based 3D Video

Another approach to acquire 3D TV content is to use sparsely arranged cameras and a model of the scene. Typical scene models range from a depth map, to a visual hull, or a detailed model of human body shapes.

In some systems, the video data from the cameras are projected onto the model to generate realistic time-varying surface textures.

One of the largest 3D video studios for virtual reality has over fifty cameras arranged in a dome, Kanade et al., “Virtualized reality: Constructing virtual worlds from real scenes,” IEEE Multimedia, Immersive Telepresence, pp. 34-47, January 1997.

The Blue-C system is one of the few 3D video systems to provide real-time capture, transmission, and instantaneous display in a spatially-immersive environment, Gross et al., “Blue-C: A spatially immersive display and 3d video portal for telepresence,” ACM Transactions on Graphics, 22, 3, pp. 819-828, 2003. Blue-C uses a centralized processor for the compression and transmission of 3D “video fragments.” This limits the scalability of that system with an increasing number of views. That system also acquires a visual hull, which is limited to individual objects, not entire indoor or outdoor scenes.

The European ATTEST project acquires HDTV color images with a depth maps for each frame, Fehn et al., “An evolutionary and optimized approach on 3D-TV” Proceedings of International Broadcast Conference, pp. 357-365, 2002.

Some experimental HDTV cameras have already been built, Kawakita et al., “High-definition three-dimension camera—HDTV version of an axi-vision camera,” Tech. Rep. 479, Japan Broadcasting Corp. (NHK), August 2002. The depth maps can be transmitted as an enhancement layer to existing MPEG-2 video streams. The 2D content can be converted using depth-reconstruction processes. On the receiver side, stereo-pair or multi-view 3D images are generated using image-based rendering.

However, even with accurate depth maps, it is difficult to render multiple high-quality views on the display side because of occlusions or high disparity in the scene. Moreover, a single video stream cannot capture important view-dependent effects, such as specular highlights.

Real-time acquisition of depth or geometry for real-world scenes remains very difficult.

Lightfield Compression and Transmission

Compression and streaming of static lightfields is also known. However, very little attention has been paid to the compression and transmission of dynamic lightfields. One can distinguish between all-viewpoint encoding, where all of the lightfield data is available at the display device, and finite-viewpoint encoding. Finite-viewpoint encoding only transmits data that are needed for a particular view by sending information from the user back to the cameras. This leads to a reduced transmission bandwidth, but that encoding is not amenable for 3D TV broadcasting.

The MPEG Ad-Hoc Group on 3D Audio and Video has been formed to investigate efficient coding strategies for dynamic light-fields and a variety of other 3D video scenarios, Smolic et al., “Report on 3dav exploration,” ISO/IEC JTC1/SC29/WG11 Document N5878, July 2003.

Experimental systems for dynamic lightfield coding use motion compensation in the time domain, called temporal encoding, or disparity prediction between cameras, called spatial encoding, Tanimoto et al., “Ray-space coding using temporal and spatial predictions,” ISO/IEC JTC1/SC29/WG11 Document M10410, December 2003.

Multi-View Auto-Stereoscopic Displays: Holographic Displays

Holography has been known since the beginning of the century. Holographic techniques were first applied to image displays in 1962. In that system, light from an illumination source is diffracted by interference fringes on a holographic surface to reconstruct the light wavefront of the original object. A hologram displays a continuous analog light-field, and real-time acquisition and display of holograms has long been considered the “holy grail” of 3D TV.

Stephen Benton's Spatial Imaging Group at MIT has been pioneering the development of electronic holography. Their most recent device, the Mark-II Holographic Video Display, uses acousto-optic modulators, beam splitters, moving mirrors, and lenses to create interactive holograms, St.-Hillaire et al., “Scaling up the MIT holographic video system,” Proceedings of the Fifth International Symposium on Display Holography, SPIE, 1995.

In more recent systems, moving parts have been eliminated by replacing the acousto-optic modulators with LCD, focused light arrays, optically-addressed spatial modulators, and digital micro-mirror devices.

All current holographic video devices use single-color laser light. To reduce a size of the display screen, they provide only horizontal parallax. The display hardware is very large in relation to the size of the image, which is typically a few millimeters in each dimension.

The acquisition of holograms still demands carefully controlled physical processes and cannot be done in real-time. At least for the foreseeable future it is unlikely that holographic systems will be able to acquire, transmit, and display dynamic, natural scenes on large displays.

Volumetric Displays

Volumetric displays scan a three-dimensional space, and individually address and illuminate voxels. A number of commercial systems for applications, such as air-traffic control, medial and scientific visualization, are now available. However, volumetric systems produce transparent images that do not provide a fully convincing three-dimensional experience. Because of their limited color reproduction and lack of occlusions, volumetric displays cannot correctly reproduce the lightfield of a natural scene. The design of large-size volumetric displays also poses some difficult obstacles.

Parallax Displays

Parallax displays emit spatially varying directional light. Much of the early 3D display research focused on improvements to Wheatstone's stereoscope. F. Ives used a plate with vertical slits as a barrier over an image with alternating strips of left-eye/right-eye images, U.S. Pat. No. 725,567 “Parallax stereogram and process for making same,” issued to Ives. The resulting device is a parallax stereogram.

To extend the limited viewing angle and restricted viewing position of stereograms, narrower slits and smaller pitch can be used between the alternating image stripes. These multi-view images are parallax panoramagrams. Stereograms and panoramagrams provide only horizontal parallax.

Spherical Lenses

In 1908, Lippmann described an array of spherical lenses instead of slits. Commonly, this is frequently called a “fly's-eye” lens sheet. The resulting image is an integral photograph. An integral photograph is a true planar lightfield with directionally varying radiance per pixel or ‘lenslet’. Integral lens sheets have been used experimentally with high-resolution LCDs, Nakajima et al., “Three-dimensional medical imaging display with computer-generated integral photography,” Computerized Medical Imaging and Graphics, 25, 3, pp. 235-241, 2001. The resolution of the imaging medium must be very high. For example, an 1024×768 pixel output with four horizontal and four vertical views requires a 12 million pixel per output image.

A 3×3 projector array uses an experimental high-resolution 3D integral video display, Liao et al., “High-resolution integral videography auto-stereoscopic display using multi-projector,” Proceedings of the Ninth International Display Workshop, pp. 1229-1232, 2002. Each projector is equipped with a zoom lens to produce a display with 2872×2150 pixels. The display provides three views with horizontal and vertical parallax. Each lenslet covers twelve pixels for an output resolution of 240×180 pixels. Special-purpose image-processing hardware is used for geometric image warping.

Lenticular Displays

Lenticular sheets have been known since the 1930s. A lenticular sheet includes a linear array of narrow cylindrical lenses called ‘lenticules’. This reduces the amount of image data by reducing vertical parallax. Lenticular images have found widespread use for advertising, magazine covers, and postcards.

Today's commercial auto-stereoscopic displays are based on variations of parallax barriers, sub-pixel filters, or lenticular sheets placed on top of LCD or plasma screens. Parallax barriers generally reduce some of the brightness and sharpness of the image. The number of distinct perspective views is generally limited.

For example, a highest resolution LCD provides 3840×2400 pixels of resolution. Adding horizontal parallax with, for example, sixteen views reduces the horizontal output resolution to 240 pixels.

To improve the resolution of a display, H. Ives invented the multi-projector lenticular display in 1931 by painting the back of a lenticular sheet with diffuse paint and using the sheet as a projection surface for thirty-nine slide projectors. Since then, a number of different arrangements of lenticular sheets and multi-projector arrays have been described.

Other techniques in parallax displays include time-multiplexed and tracking-based systems. In time-multiplexing, multiple views are projected at different time instances using a sliding window or LCD shutter. This inherently reduces the frame rate of the display and can lead to noticeable flickering. Head-tracking designs focus mostly on the display of high-quality stereo image pairs.

Multi-Projector Displays

Scalable multi-projector display walls have recently become popular, and many systems have been implemented, e.g., Raskar et al., “The office of the future: A unified approach to image-based modeling and spatially immersive displays,” Proceedings of SIGGRAPH '98, pp. 179-188, 1998. Those systems offer very high resolution, flexibility, excellent cost-performance, scalability, and large-format images. Graphics rendering for multi-projector systems can be efficiently parallelized on clusters of PCs.

Projectors also provide the necessary flexibility to adapt to non-planar display geometries. For large displays, multi-projector systems remain the only choice for multi-view 3D displays until very high-resolution display media, e.g., organic LEDs, become available. However, manual alignment of many projectors becomes tedious, and downright impossible in the case of non-planar screens or 3D multi-view displays.

Some systems use cameras and a feedback loop to automatically compute relative projector poses for automatic projector alignment. A digital camera mounted on a linear 2-axis stage can also be used to align projectors for a multi-projector integral display system.

### SUMMARY OF THE INVENTION

The invention provides a system and method for acquiring and transmitting 3D images of dynamic scenes in real time. To manage the high demands on computation and bandwidth, the invention uses a distributed, scalable architecture.

The system includes an array of cameras, clusters of network-connected processing modules, and a multi-projector 3D display unit with a lenticular screen. The system provides stereoscopic color images for multiple viewpoints without special viewing glasses. Instead of designing perfect display optics, we use cameras for the automatic adjustment of the 3D display.

The system provides real-time end-to-end 3D TV for the very first time in the long history of 3D displays.

### BRIEF DESCRIPTION OF THE DRAWINGS

FIG. 1 is a block diagram of a 3D TV system according to the invention;

FIG. 2 is a block diagram of decoder modules and consumer modules according to the invention;

FIG. 3 is a top view of a display unit with rear projection according to the invention;

FIG. 4 is a top view of a display unit with front projection according to the invention; and

FIG. 5 is a schematic of horizontal shift between viewer-side and projection-side lenticular sheets.

### DETAILED DESCRIPTION OF THE PREFERRED EMBODIMENT

System Architecture

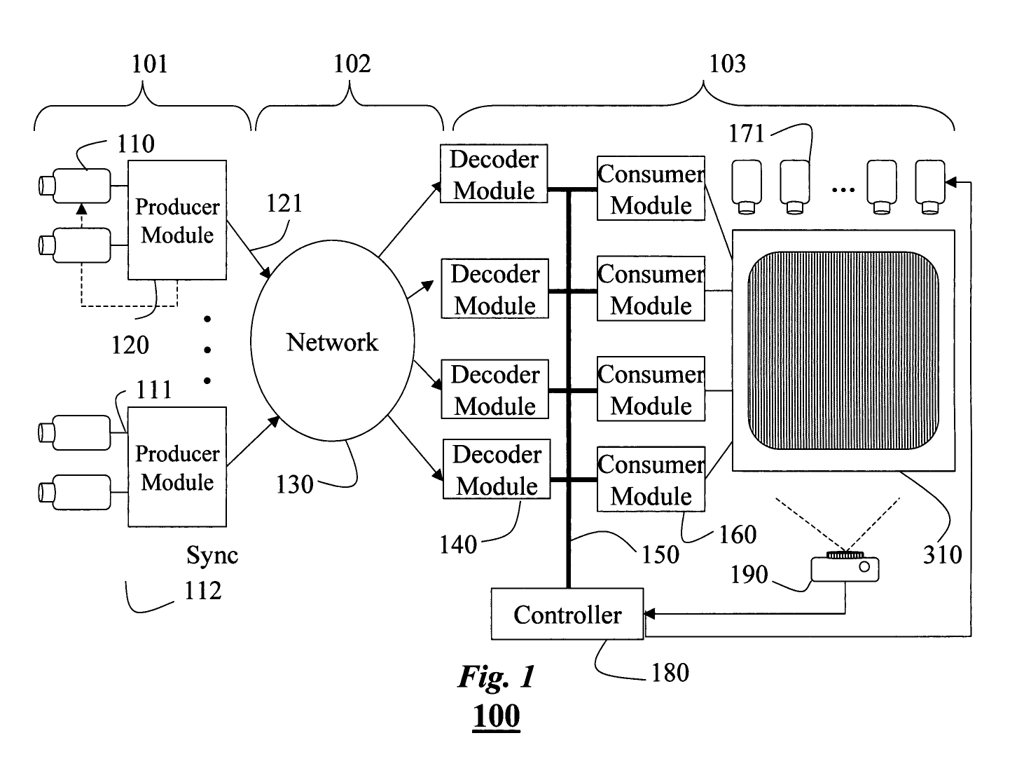

FIG. 1 shows a 3D TV system according to our invention. The system 100 includes an acquisition stage 101, a transmission stage 102, and a display stage 103.

The acquisition stage 101 includes of an array of synchronized video cameras 110. Small clusters of cameras are connected to producer modules 120. The producer modules capture real-time, uncompressed videos and encode the videos using standard MPEG coding to produce compressed video streams 121. The producer modules also generate viewing parameters.

The compressed video streams are sent over a transmission network 130, which could be broadcast, cable, satellite TV, or the Internet.

In the display stage 103, the individual video streams are decompressed by decoder modules 140. The decoder modules are connected by a high-speed network 150, e.g., gigabit Ethernet, to a cluster of consumer modules 160. The consumer modules render the appropriate views and send output images to a 2D, stereo-pair 3D, or multi-view 3D display unit 310.

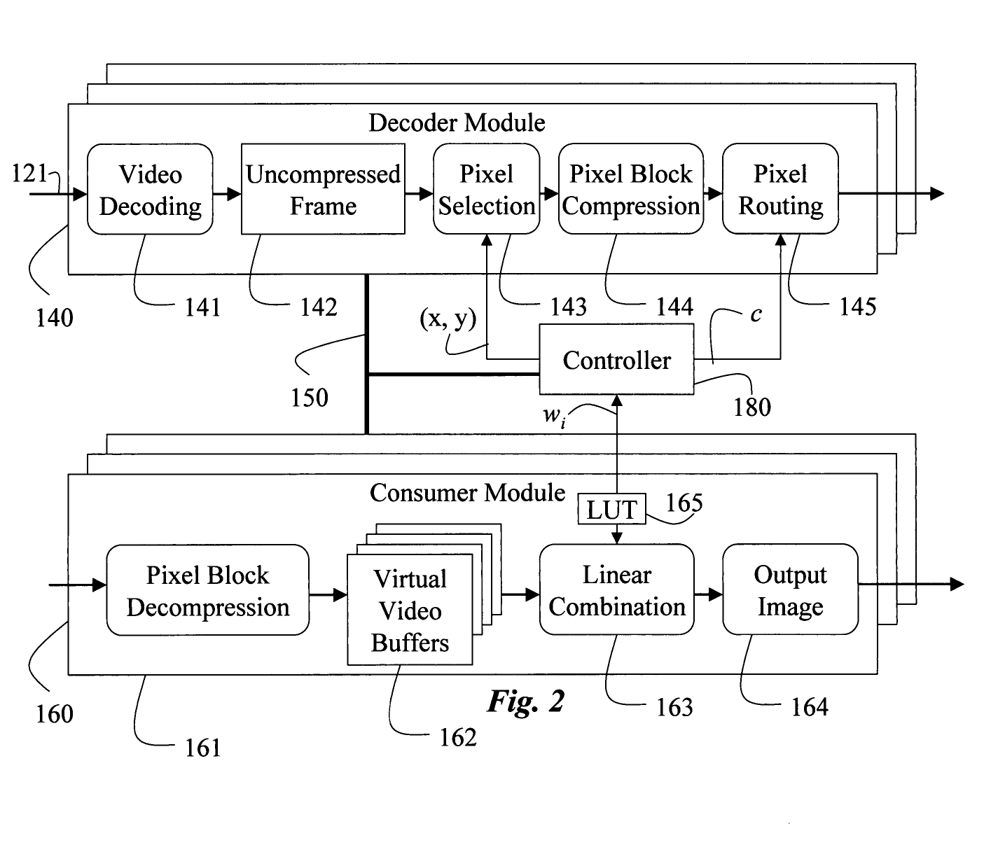

A controller 180 broadcasts the virtual view parameters to the decoder modules and the consumer modules, see FIG. 2. The controller is also connected to one or more cameras 190. The cameras are placed in a projection area and/or the viewing area. The cameras provide input capabilities for the display unit.

Distributed processing is used to make the system 100 scalable in the number of acquired, transmitted, and displayed views. The system can be adapted to other input and output modalities, such as special-purpose lightfield cameras, and asymmetric processing. Note that the overall architecture of our system does not depend on the particular type of display unit.

System Operation

Acquisition Stage

Each camera 110 acquires a progressive high-definition video in real-time. For example, we use sixteen color cameras with 1310×1030, 8 bits per pixel CCD sensors. The cameras are connected by an IEEE-1394 ‘FireWire’ high performance serial bus 111 to the producer modules 120.

The maximum transmitted frame rate at full resolution is, e.g., twelve frames per second. Two cameras are connected to each one of eight producer modules. All modules in our prototype have 3 GHz Pentium 4 processors, 2 GB of RAM, and run Windows XP. It should be noted that other processors and software can be used.

Our cameras 110 have an external trigger that allows complete control over video synchronization. We use a PCI card with custom programmable logic devices (CPLD) to generate the synchronization signals 112 for the cameras 110. Although it is possible to build camera arrays with software synchronization, we prefer precise hardware synchronization for dynamic scenes.

Because our 3D display shows horizontal parallax only, we arranged the cameras 110 in a regularly spaced linear and horizontal array. In general, the cameras 110 can be arranged arbitrarily because we are using image-based rendering in the consumer modules to synthesize new views, as described below. Ideally, the optical axis of each camera is perpendicular to a common camera plane, and an ‘up vector’ of each camera is aligned with the vertical axis of the camera.

In practice, it is impossible to align multiple cameras precisely. We use standard calibration procedures to determine the intrinsic, i.e., focal length, radial distortion, color calibration, etc., and extrinsic, i.e., rotation and translation, camera parameters. The calibration parameters are broadcast as part of the video stream as viewing parameters, and the relative differences in camera alignment can be handled by rendering corrected views in the display stage 103.

A densely spaced array of cameras provides the best lightfield capture, but high-quality reconstruction filters can be used when the lightfield is undersampled.

A large number of cameras can be placed in a TV studio. A subsets of cameras can be selected by a user, either a camera operator or a viewer, with a joystick to display a moving 2D/3D window of the scene to provide a free-viewpoint video.

Transmission Stage

Transmitting sixteen uncompressed video streams with 1310×1030 resolution and 24 bits per pixel at 30 frames per second requires 14.4 Gb/sec bandwidth, which is well beyond current broadcast capabilities. There are two basic design choices for compression and transmission of dynamic multi-view video data. Either the data from multiple cameras are compressed using spatial or spatio-temporal encoding, or each video stream is compressed individually using temporal encoding. Temporal encoding also uses spatial encoding within each frame, but not between views.

The first option offers higher compression, because there is a high coherence between the views. However, higher compression requires that multiple video streams are compressed by a centralized processor. This compression-hub architecture is not scalable, because the addition of more views eventually overwhelms the internal bandwidth of the encoders.

Consequently, we use temporal encoding of individual video streams on distributed processors. This strategy has other advantages. Existing broadband protocols and compression standards do not need to be changed. Our system is compatible with the conventional digital TV broadcast infrastructure and can co-exist in perfect harmony with 2D TV.

Currently, digital broadcast networks carry hundreds of channels and perhaps a thousand or more channels with MPEG-4. This makes it possible to dedicate any number of channels, e.g., sixteen, to 3D TV. Note, however, that our preferred transmission strategy is broadcasting.

Other applications, e.g., peer-to-peer 3D video conferencing, can also be enabled by our system. Another advantage of using existing 2D coding standards is that the decoder modules on the receiver are well established and widely available. Alternatively, the decoder modules 140 can be incorporated in a digital TV ‘set-top’ box. The number of decoder modules can depend on whether the display is 2D or multi-view 3D.

Note that our system can adapt to other 3D TV compression algorithms, as long as multiple views can be encoded, e.g., into 2D video plus depth maps, transmitted, and decoded in the display stage 102.

Eight producer modules are connected by gigabit Ethernet to eight consumer modules 160. Video streams at full camera resolution (1310×1030) are encoded with MPEG-2 and immediately decoded by the producer modules. This essentially corresponds to a broadband network with a very large bandwidth and almost no delay.

The gigabit Ethernet 150 provides all-to-all connectivity between the decoder modules and the consumer modules, which is important for our distributed rendering and display implementation.

Display Stage

The display stage 103 generates appropriate images to be displayed on the display unit 310. The display unit can be a multi-view 3D unit, a head-mounted 2D stereo unit, or a conventional 2D unit. To provide this flexibility, the system needs to be able to provide all possible views, i.e., the entire lightfield, to the end users at every time instance.

The controller 180 requests one or more virtual views by specifying viewing parameters, such as position, orientation, field-of-view, and focal plane, of virtual cameras. The parameters are then used to render the output images accordingly.

FIG. 2 shows the decoder modules and consumer modules in greater detail. The decoder modules 140 decompress 141 the compressed videos 121 to uncompressed source frames 142, and stores current decompressed frame in virtual video buffers (VVB) 162 via the network 150. Each consumer 160 has a VVB storing data of all current decoded frames, i.e., all acquired views at a particular time instance.

The consumer modules 160 generate an output image 164 for the output video by processing image pixels from multiple frames in the VVBs 162. Due to bandwidth and processing limitations, it is impossible for each consumer module to receive the complete source frames from all the decoder modules. This would also limit the scalability of the system. The key observation is that the contributions of the source frames to the output image of each consumer can be determined in advance. We now focus on the processing for one particular consumer, i.e., one particular virtual view and its corresponding output image.

For each pixel o(u, v) in the output image 164, the controller 180 determines a view number v and the position (x, y) of each source pixel s(v, x, y) that contributes to the output pixel. Each camera has an associated unique view number for this purpose, e.g., 1 to 16. We use unstructured lumigraph rendering to generate output images from the incoming video streams 121.

Each output pixel is a linear combination of k source pixels:

$$o ( u , v ) = {\sum }_{i = 0}^{k} {w}_{i} s ( v , x , y ) . \qquad ( 1 )$$

Blending weights wᵢ can be predetermined by the controller based on the virtual view information. The controller sends the positions (x, y) of the k source pixels (s) to each decoder v for pixel selection 143. An index c of a requesting consumer module is sent to the decoder for pixel routing 145 from the decoder modules to the consumer module.

Optionally, multiple pixels can be buffered in the decoder for pixel block compression 144, before the pixels are sent over the network 150. The consumer module decompresses 161 the pixel blocks and stores each pixel in VVB number v at position (x, y).

Each output pixel requires pixels from k source frames. That means that the maximum bandwidth on the network 150 to the VVB is k times the size of the output image times the number of frames per second (fps). For example, for k=3, 30 fps and HDTV output resolution, e.g., 1280×720 at 12 bits per pixel, the maximum bandwidth is 118 MB/sec. This can be substantially reduced when the pixel block compression 144 is used, at the expense of more processing. To provide scalability, it is important that this bandwidth is independent of the total number of transmitted views, which is the case in our system.

The processing in each consumer module 160 is as follows. The consumer module determines equation (1) for each output pixel. The weights wᵢ are predetermined and stored in a lookup table (LUT) 165. The memory requirement of the LUT 165 is k times the size of the output image 164. In our example above, this corresponds to 4.3 MB.

Assuming lossless pixel block compression, consumer modules can easily be implemented in hardware. That means that the decoder modules 140, network 150, and consumer modules can be combined on one printed circuit board, or manufactured as an application-specific integrated circuit (ASIC).

We are using the term pixel loosely. It means typically one pixel, but it could also be an average of a small, rectangular block of pixels. Other known filters can be applied to a block of pixels to produce a single output pixel from multiple surrounding input pixels.

Combining 163 pre-filtered blocks of the source frames for new effects, such as a depth-of-field is novel for image-based rendering. Particularly, we can perform efficiently multi-view rendering of pre-filtered images by using summed-area tables. The per-filtered (summed) blocks of pixels are then combined using equation (1) to form output pixels.

We can also use higher-quality blending, e.g., undersampled lightfields. So far, the requested virtual views are static. Note, however, that all the source views are sent over the network 150. The controller 180 can update dynamically the lookup tables 165 for pixel selection 143, routing 145, and combining 163. This enables navigation of the lightfield is similar to real-time lightfield cameras with random-access image sensors, and frame buffers in the receiver.

Display Unit

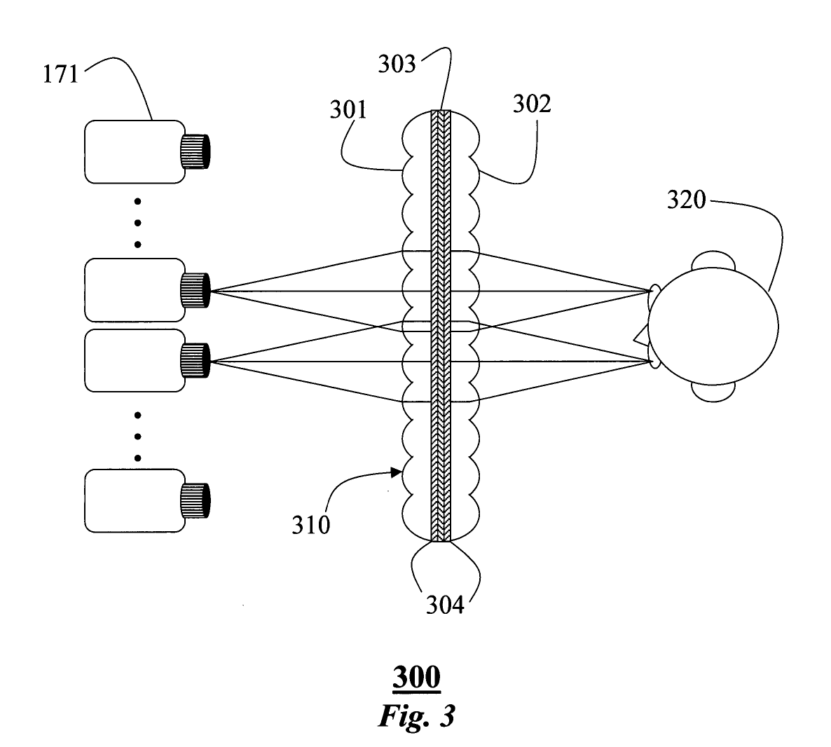

As shown in FIG. 3, for a rear-projection arrangement, the display unit is constructed as a lenticular screen 310. We use sixteen projectors to display the output videos on the display unit. with 1024×768 output resolution. Note that the resolution of the projectors can be less than the resolution of our acquired and transmitted video, which is 1310×1030 pixels.

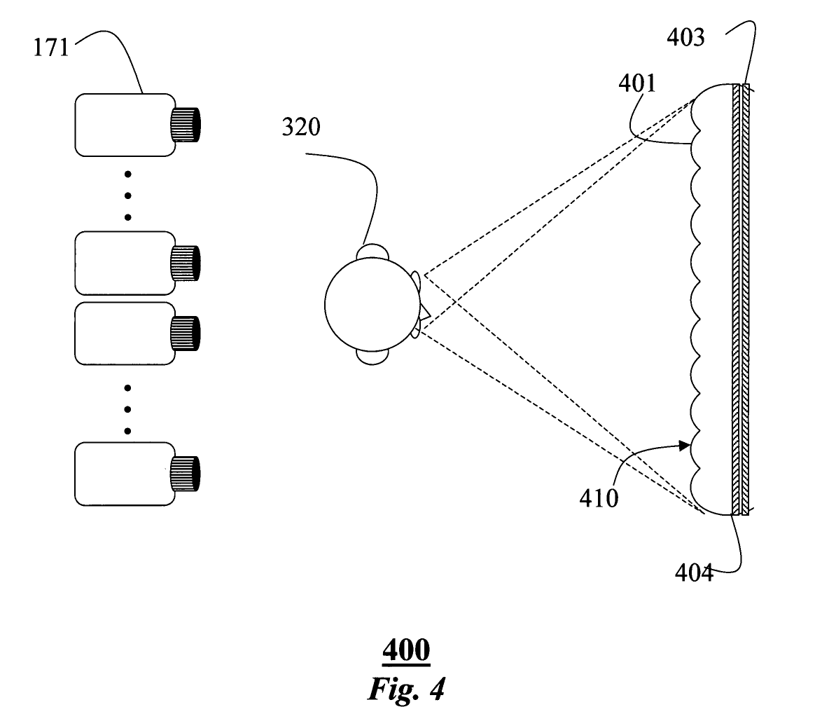

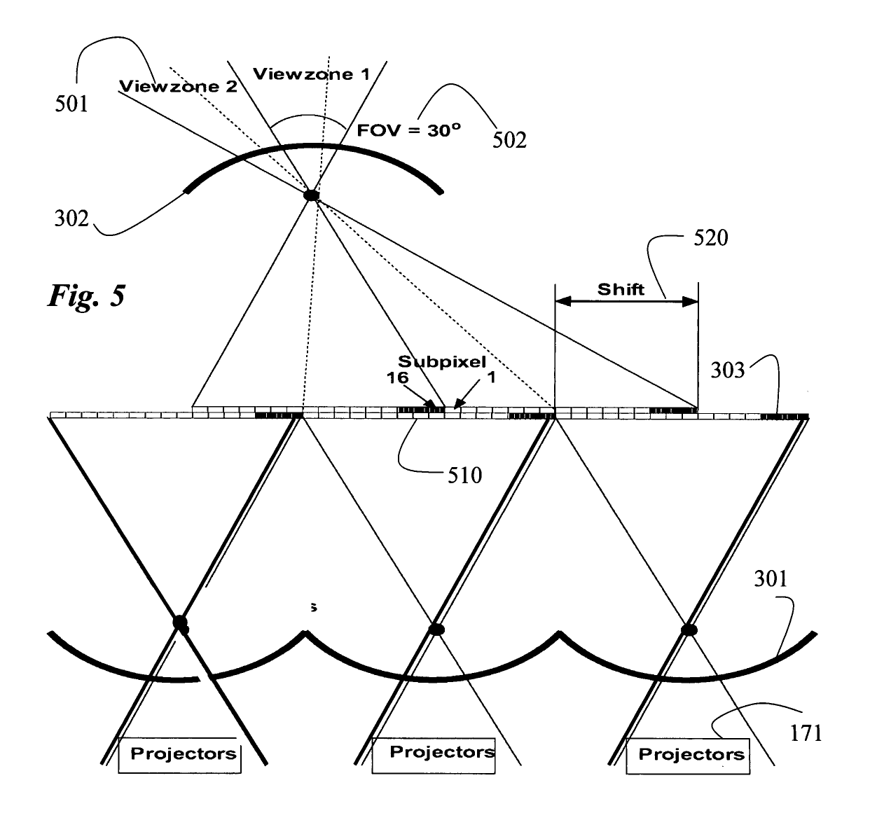

The two key parameters of lenticular sheets 310 are the field-of-view (FOV) and the number of lenticules per inch (LPI), also see FIGS. 4 and 5. The area of the lenticular sheets is 6×4 square feet with 30° FOV and 15 LPI. The optical design of the lenticules is optimized for multi-view 3D display.

As shown in FIG. 3, the lenticular sheet 310 for rear-projection displays includes a projector-side lenticular sheet 301, a viewer-side lenticular sheet 302, a diffuser 303, and substrates 304 between the lenticular sheets and diffuser. The two lenticular sheets 301-302 are mounted back-to-back on the substrates 304 with the optical diffuser 303 in the center. We use a flexible rear-projection fabric.

The back-to-back lenticular sheets and the diffuser are composited into a single structure. To align the lenticules of the two sheets as precisely as possible, a transparent resin is used. The resin is UV-hardened and aligned.

The projection-side lenticular sheet 301 acts as a light multiplexer, focusing the projected light as thin vertical stripes onto the diffuser, or a reflector 403 for front-projection, see FIG. 4 below. Considering each lenticule to be an ideal pinhole camera, the stripes on the diffuser/reflector capture the view-dependent radiance of a three-dimensional lightfield, i.e., 2D position and azimuth angle.

The viewer-side lenticular sheet acts as a light de-multiplexer and projects the view-dependent radiance back to a viewer 320.

FIG. 4 shows and alternative arrangement 400 for a front-projection display. The lenticular sheet 410 for the front-projection displays includes a projector-side lenticular sheet 401, a reflector 403, and a substrate 404 between the lenticular sheets and reflector. The lenticular sheet 401 is mounted using the substrate 404 and the optical reflector 403. We use a flexible front-projection fabric.

Ideally, the arrangements of the cameras 110 and the arrangement of the projectors 171, with respect to the display unit, are substantially identical. An offset in the vertical direction between neighboring projectors may be necessary for mechanical mounting reasons, which can lead to a small loss of vertical resolution in the output image.

As shown in FIG. 5, a viewing zone 501 of a lenticular display is related to the field-of-view (FOV) 502 of each lenticule. The whole viewing area, i.e., 180 degrees, is partitioned into multiple viewing zones. In our case, the FOV is 30°, leading to six viewing zones. Each viewing zone corresponds to sixteen sub-pixels 510 on the diffuser 303.

If the viewer 320 moves from one viewing zone to the next, a sudden image ‘shift’ 520 appears. The shift occurs because at the border of the viewing zone, we move from the 16^{th} sub-pixel of one lenticule to the first sub-pixel of a neighboring lenticule. Furthermore, a translation of the lenticular sheets with respect to each other leads to a change, i.e., apparent rotation, of the viewing zones.

The viewing zone of our system is very large. We estimate the depth-of-field ranges from about two meters in front of the display to well beyond fifteen meters. As the viewer moves away, the binocular parallax decreases, while the motion parallax increases. We attribute this to the fact that the viewer sees multiple views simultaneously if the display is in the distance. Consequently, even small movements with the head lead to big motion parallax. To increase the size of the viewing zones, lenticular sheets with wider FOV, and more LPI can be used.

A limitation of our 3D display is that it provides only horizontal parallax. We believe that this is not a serious issue, as long as the viewer remains static. This limitation can be corrected by using integral lens sheets and two-dimensional camera and projector arrays. Head tracking can also be incorporated for display images with some vertical parallax on our lenticular screen.

Our system is not restricted to using lenticular sheets with the same LPI on the projection and viewer side. One possible design has twice the number of lenticules on the projector side. A mask on top of the diffuser can cover every other lenticule. The sheets are off-set such that a lenticule on the projector side provides the image for one lenticule on the viewing side. Other multi-projector displays with integral sheets or curved-mirror retro-reflection are possible as well.

We can also add vertically aligned projectors with diffusing filters of different strengths, e.g., dark, medium, and bright. Then, we can change the output brightness for each view by mixing pixels from different projectors.

Our 3D TV system can also be used for point-to-point transmission, such as in video conferencing.

We also adapt our system to multi-view display units with a deformable display media, such as organic LEDs. If we know the orientation and relative position of each display unit, then we can render new virtual views by dynamically routing image information from the decoder modules to the consumers.

Among other applications, this allows the design of “invisibility cloaks” by displaying view-dependent images on an object using a deformable display media, e.g., miniature multi-projectors pointed at front-projection fabric draped around the object, or small organic LEDs and lenslets that are mounted directly on the object surface. This “invisibility cloak” shows view-dependent images that would be seen if the object were not present. For dynamically changing scenes one can put multiple miniature cameras around or on the object to acquire the view-dependent images that are then displayed on the “invisibility cloak.”

Effect of the Invention

We provide a 3D TV system with a scalable architecture for distributed acquisition, transmission, and rendering of dynamic lightfields. A novel distributed rendering method allows us to interpolate new views using little computation and moderate bandwidth.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A three-dimensional television system, comprising:
an acquisition stage, comprising:
a plurality of video cameras, each video camera configured to acquire a video of a dynamically changing scene in real-time;
means for synchronizing the plurality of video cameras; and
a plurality of producer modules connected to the plurality of video cameras, the producers modules configured to compress the videos to compressed videos and to determine viewing parameters of the plurality of video cameras;
a display stage, comprising:
a plurality of decoder modules configured to decompress the compressed videos to uncompressed videos;
a plurality of consumer modules configured to generate a plurality of output videos from the decompressed videos;
a controller configured to broadcast the viewing parameters to the plurality of decoder modules and the plurality of consumer modules;
a three-dimensional display unit configured to concurrently display the output videos according to the viewing parameters; and
means of connecting the plurality of decoder modules, the plurality of consumer modules, and the plurality of display units; and
a transmission stage, connecting the acquisition stage to the display stage, configured to transport the plurality of compressed videos and the viewing parameters.

2. The system of claim 1, further comprising a plurality of cameras to acquire calibration images displayed on the three-dimensional display unit to determine the viewing parameters.

3. The system of claim 1, in which the display units are projectors.

4. The system of claim 1, in which the display units are organic light emitting diodes.

5. The system of claim 1, in which the three-dimensional display unit uses front-projection.

6. The system of claim 1, in which the three-dimensional display unit uses rear-projection.

7. The system of claim 1, in which the display unit uses two-dimensional display element.

8. The system of claim 1, in which the display unit is flexible, and further comprising passive display elements.

9. The system of claim 1, in which the display unit is flexible, and further comprising active display elements.

10. The system of claim 1, in which different output images are displayed depending on a viewing direction of a viewer.

11. The system of claim 1, in which static view-dependent images of an environment are displayed such that a display surface disappears.

12. The system of claim 1, in which dynamic view-dependent images of an environment are displayed such that a display surface disappears.

13. The system of claim 11 or 12, in which the view-dependent images of the environment are acquired by a plurality of cameras.

14. The system of claim 1, in which each producer module is connected to a subset of the plurality of video cameras.

15. The system of claim 1, in which the plurality of video cameras are in a regularly spaced linear and horizontal array.

16. The system of claim 1, in which the plurality of video cameras are arranged arbitrarily.

17. The system of claim 1, in which an optical axis of each video camera is perpendicular to a common plane, and the up vectors of the plurality of video cameras are vertically aligned.

18. The system of claim 1, in which the viewing parameters include intrinsic and extrinsic parameters of the video cameras.

19. The system of claim 1, further comprising:
means for selecting a subset of the plurality of cameras for acquiring a subset of videos.

20. The system of claim 1, in which each video is compressed individually and temporally.

21. The system of claim 1, in which the viewing parameters include a position, orientation, field-of-view, and focal plane, of each video camera.

22. The system of claim 1, in which the controller determines, for each output pixel o(x, y) in the output video, a view number v and a position of each source pixel s(v, x, y) in the decompressed videos that contributes to the output pixel in the output video.

23. The system of claim 22, in which the output pixel is a linear combination of k source pixels according to
$$o ( u , v ) = {\sum }_{i = 0}^{k} {w}_{i} s ( v , x , y ) ,$$
where blending weights wᵢ are predetermined by the controller based on the viewing parameters.

24. The system of claim 22, in which a block of the source pixels contribute to each output pixel.

25. The system of claim 1, in which the three-dimensional display unit includes a display-side lenticular sheet, a viewer-side lenticular sheet, a diffuser, and substrate between each lenticular sheets and the diffuser.

26. The system of claim 1, in which the three-dimensional display unit includes a display-side lenticular sheet, a reflector, and a substrate between the lenticular sheets and the reflector.

27. The system of claim 1, in which an arrangement of the cameras and an arrangement of the display units, with respect to the display unit, are substantially identical.

28. The system of claim 1, in which the plurality of cameras acquire high-dynamic range videos.

29. The system of claim 1, in which the display units display high-dynamic range images of the output videos.

30. A three-dimensional television system, comprising:
an acquisition stage, comprising:
a plurality of video cameras, each video camera configured to acquire an input video of a dynamically changing scene in real-time;
a display stage, comprising:
a three-dimensional display unit configured to concurrently display output videos generated from the input videos; and
a transmission network connecting the acquisition stage to the display stage.

31. A method for providing three-dimensional television, comprising:
acquiring a plurality of synchronized videos of a dynamically changing scene in real-time;
determining viewing parameters of the plurality of videos;
generating a plurality of output videos from the plurality of synchronized input videos according to the viewing parameters; and
displaying concurrently the plurality of output videos on a three-dimensional display unit.
